(19) United States
(12) Patent Application Publication
(10) Pub. No.: US 2011/0284473 A1
(43) Pub. Date: Nov. 24, 2011

(54) MOBILE CLEANING METHOD AND MOBILE CLEANING MODULE FOR FLUIDS

(76) Inventor: Markus Kemper, Hamm (DE)

(21) Appl. No.: 13/125,845

(22) PCT Filed: Oct. 27, 2009
(86) PCT No.: PCT/EP2009/064131

§ 371 Date: Aug. 15, 2011

(30) Foreign Application Priority Data
Oct. 27, 2008 (CH) 01681/08

(51) Int. Cl. B01D 35/00; F01M 1/10; B01D 35/143; B01D 36/00; B01D 35/14

(52) U.S. Cl. 210/739; 210/774; 210/96.1; 210/149; 210/103; 210/85; 210/105

(57) ABSTRACT

A cleaning method is provided for fluids of a fluid circuit (31) of a mobile device (2) comprising a mobile cleaning module (1), wherein the mobile cleaning module (1) comprises at least one connection element (3, 4, 5, 6) for making a connection to the fluid circuit (31) so that the fluid can be withdrawn from the fluid circuit (31), at least one filter unit (27) for cleaning the fluid, and a connection element (3, 4) for making a connection to the fluid circuit (31) so that the fluid can fed back to the fluid circuit. In a first step, the mobile cleaning module (1) is connected to the fluid circuit by way of the connection element (3, 4, 5, 6). In a next step, the fluid is at least partially withdrawn from the fluid circuit (31) and then the fluid is led through the filter unit (31). Preferably, the fluid can be heated or cooled prior to being introduced to the filter unit (27). In a last step, the cleaned fluid is fed back to the fluid circuit (31) of the mobile device (2).

### TECHNICAL FIELD OF THE INVENTION

The present invention relates to a cleaning method for fluids according to the features of the preamble of claim 1, and to a mobile cleaning module for cleaning fluids according to the features of claim 9.

### PRIOR ART

The prior art discloses a very wide variety of ways of cleaning fluids in mobile devices.

For example, a motor vehicle contains an oil filter which is arranged in the oil circuit and thus continuously filters the lubricating oil during operation. This type of filtering has the advantage that the lubricant is filtered continuously. However, it is disadvantageous that the filter becomes heavily soiled over the course of time and returns undesirable particles, for example heavy metal particles, to the lubricant if the filter is not replaced in good time.

Furthermore, the entire lubricant has to be replaced at periodic intervals. In the process, the old lubricant is removed from the lubricant circuit and replaced by new lubricant. A disadvantage here is the fact that the fluid removed from the fluid circuit is disposed of.

### SUMMARY OF THE INVENTION

Proceeding from the prior art, the invention is based on the object of specifying a device and a method which overcome the disadvantages of the prior art. In particular, it is an object of the present invention to provide a device and a method with which a fluid of a fluid circuit in a mobile device can be periodically cleaned, wherein the cleaning is intended to take place outside the fluid circuit.

This object is achieved by a method with the features of patent claim 1. According thereto, a cleaning method for fluids of a fluid circuit of a mobile device with a mobile cleaning module is indicated, wherein the mobile cleaning module comprises at least one connecting element for producing a connection to the fluid circuit such that the fluid can be removed from the fluid circuit, at least one filter unit for cleaning the fluid, and a connecting element for producing a connection to the fluid circuit such that the fluid can be fed back to the fluid circuit. In a first step of the method, the mobile cleaning module is connected to the fluid circuit via the connecting element. In a subsequent step, the fluid is at least partially, preferably completely, removed from the fluid circuit. The fluid is subsequently heated or cooled preferably to a predetermined temperature and, after the predetermined temperature is reached, the fluid is guided through the filter unit. In a final step, the cleaned fluid is fed back to the fluid circuit of the mobile device. Preferably upstream and/or downstream of the filter unit, a physical property and/or chemical property of the fluid are/is determined.

Preferably, the determination of the property comprises measuring an actual value of the viscosity by means of a viscosimeter, and in that said actual value is compared with a predetermined desired value, during the measurement of the viscosity downstream of the filter unit and upon a predetermined difference between the actual value and desired value being exceeded, the viscosity being corrected by adding an additive and/or a fluid of a type identical to the fluid, or

during the measurement of the viscosity downstream of the filter unit and upon a predetermined difference between the actual value and desired value being exceeded, the fluid being guided into a tank of the cleaning device, with fresh fluid then being fed to the mobile device.

Preferably, the determination of the property comprises detecting the number of metallic particles in the fluid,

during the determination upstream of the filter unit and if the number of detected particles is greater than a predefined value, a warning signal is generated alerting the user to a defect at the mobile device, or during the determination downstream of the filter unit and upon a predetermined difference between the actual value and desired value being exceeded, the fluid being guided into a tank of the cleaning device, with fresh fluid then being fed to the mobile device.

The determination of the chemical and/or physical property has the advantage of enabling conclusions to be drawn about the quality of the cleaning and/or about the wear in the mobile device.

The fluid is particularly preferably brought in the region of the connecting elements to a predetermined temperature by heating or cooling.

Upstream and/or downstream of the filter unit, a predetermined volume of the fluid is preferably guided by a shut off member into at least one external container, the removed volume being compensated for by fresh fluid being fed in prior to being returned. The removed volume is then stored in an external container, and the latter can be put aside for subsequent analysis purposes.

The removed volume of fluid is preferably detected during or after the removal of the fluid from the fluid circuit. Subsequently, a differential volume to a predetermined desired volume is ascertained. The differential volume of the fluid is then fed to the fluid circuit in particular in the form of new or fresh fluid.

A new or fresh fluid is preferably added continuously to the fluid removed from the fluid circuit prior to being returned to the fluid circuit. The returned volume is detected during or prior to the return into the fluid circuit. The method is used until the returned volume corresponds to a predetermined desired volume. The removed volume of fluid is optionally also detected during or after removal of the fluid from the fluid circuit.

A mobile cleaning module for carrying out the method comprises at least one connection point for connection to the at least one connection point of the mobile device, at least one measuring means for determining at least one physical property and/or at least one chemical property of the fluid, and a filter unit which is connected to the at least one connection point via a pipeline system. A temperature element which heats or cools the fluid removed from the fluid circuit to a predetermined temperature is preferably provided. The fluid can be removed from the fluid circuit of the mobile device via the connection of the connection points of the mobile device to those of the mobile cleaning module. The fluid can be guided through the filter element and can be cleaned. The cleaned fluid can be fed back into the fluid circuit via said connection.

The cleaning module preferably furthermore comprises a pump by means of which the fluid can be removed from the fluid circuit and/or the fluid can be circulated in the cleaning module.

The measuring means preferably is a viscosimeter which is arranged downstream of the filter unit and with which the actual value of the viscosity of the fluid can be determined, the actual value being able to be compared with a predetermined desired value, and in that either upon a predetermined difference between the actual value and desired value being exceeded, the viscosity can be corrected by adding an additive and/or a fluid of identical type to the fluid via a storage container which is connected to the line system and has a metering device, or

in an optional step upon a predetermined difference between the actual value and desired value being exceeded, the fluid is guided into a tank of the cleaning device, with fresh fluid then being fed to the mobile device.

The measuring means is preferably at least one quality sensor which is arranged upstream and/or downstream of the filter unit and with which the metallic particles in the fluid can be detected,

during the determination upstream of the filter unit and if the number of detected particles is greater than a predefined value, a warning signal being generated alerting the user to a defect at the mobile device, or during the determination downstream of the filter unit and upon a predetermined deviation between the actual value and desired value being exceeded, the fluid being guided into a tank of the cleaning device, with fresh fluid then being fed to the mobile device.

The quality sensor and viscosimeter may be arranged as alternatives or together.

The temperature element is preferably arranged in the region of the connecting point, in particular in the front region of a probe. In this case, the fluid can be heated or cooled to a predetermined temperature even as it is being removed.

The cleaning module preferably comprises an additional container for receiving the cleaned fluid and/or a new (i.e. fresh) fluid and/or an additive. The fluid in the additional container can be dispensed into the fluid circuit of the mobile device.

Further advantageous embodiments are characterized in the dependent claims.

### BRIEF DESCRIPTION OF THE DRAWING

Preferred embodiments are described in more detail by way of example below with reference to the drawing, in which:

FIG. 1 shows a view of a simplified schematic diagram of a mobile cleaning module for removing a fluid from, treating and returning said fluid to, a mobile device according to the present invention;

FIG. 2 shows a view of a further simplified schematic diagram of a mobile cleaning module for removing a fluid from, treating and returning said fluid to, a mobile device;

FIG. 3 shows a view of a detailed schematic diagram from FIG. 2;

FIG. 4 shows a detailed view of a removal circuit for removing a fluid from a fluid circuit;

FIG. 5 shows a detailed view of the circuit for heating/cooling a removed fluid;

FIG. 6 shows a detailed view of a cleaning circuit for cleaning the removed fluid;

FIG. 7 shows a detailed view of the return of the cleaned fluid into the fluid circuit; and

FIG. 8 shows a view of a detailed schematic diagram of a cleaning module for removing a fluid from, treating and returning said fluid to, a mobile device according to a further embodiment of the present invention.

### DESCRIPTION OF PREFERRED EXEMPLARY EMBODIMENTS

Possible exemplary embodiments are described with reference to the drawings. The drawings and the description show preferred exemplary embodiments and should not be interpreted as limiting the invention defined by the claims.

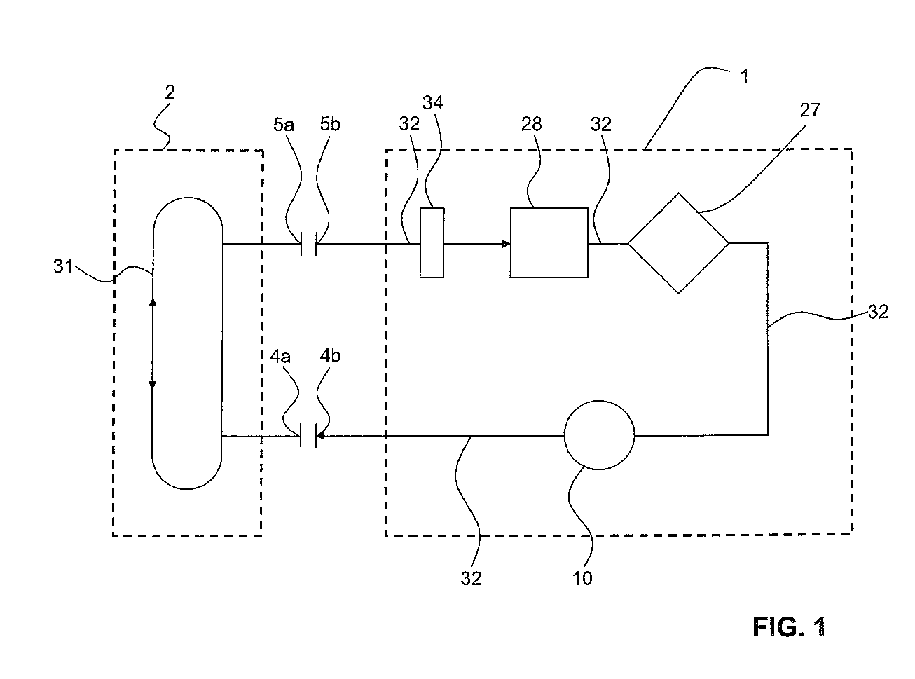

FIG. 1 shows a view of a schematic diagram of a system according to the present invention. The system essentially comprises a mobile cleaning module 1 which is connectable to a mobile device 2. The mobile cleaning module 1 can be connected to the mobile device 2 in such a manner that the dirty fluid can be removed from the fluid circuit 31 of the mobile device 2, that the dirty fluid can be treated and cleaned in the mobile cleaning module 1, and that the treated fluid can be fed back to the fluid circuit 31.

A mobile device 2 is understood as meaning any type of device which is capable of moving a mass in the vertical and/or horizontal position thereof by means of a drive. A motor vehicle, a truck, an elevator, a ship, etc., may be mentioned here by way of example. All of these mobile devices comprise at least one fluid circuit 31 in which a fluid circulates. In the case of a motor vehicle, examples which should be mentioned here include the lubricating circuit in which a lubricating oil circulates, and the brake circuits in which there is a brake fluid. Other fluid circuits, for example coolant circuits of an air-conditioning system arranged on the mobile device, are likewise conceivable. The fluid circuit 31 typically comprises at least two connection points 4a, 5a to which the mobile cleaning module 1 can be connected. The dirty fluid can be removed from the fluid circuit 31 via one connection point 5a and the fluid treated or cleaned by the mobile cleaning module 1 can be fed back to the fluid circuit 31 via the other connection point 4a.

The mobile cleaning module 1 here essentially comprises two connection points 4b, 5b, at least one filter unit 27 and a pump 10. A pipe system 32 connects the connection points 4b, 5b to the filter unit 27 and to the pump 10, which are arranged serially with respect to each other. Furthermore, the mobile cleaning module 1 comprises suitable input means and control devices in order to activate the cleaning operation and to set the pump 10 into operation. The input means can comprise, for example, a control console with various operating elements, such as key buttons etc., or a touch-sensitive screen. In this case, the control device is supplied with electric power via a current supply and serves to control the pump or the other element required for operation. In addition, there can be a display device which provides the user with information regarding the progress of the cleaning operation.

The two connection points 4b, 5b are connectable to the corresponding connection points 4a, 5b of the mobile device 1. For this purpose, for example, corresponding rapid-action couplings can be provided.

The filter unit 27 is composed of at least one filter, preferably of at least two filters arranged parallel to each other. Four filters arranged parallel to one another are particularly preferably used. As an alternative, and depending on requirements regarding the degree of purity to be obtained, there may also be three, five, six or more filters. The filter unit 27 is preferably connected to the pipe system 32 by rapid-action closures, this permitting rapid replacement of soiled filters.

In order to increase the throughput and therefore the cleaning power of the mobile cleaning module 1, it would also be conceivable to arrange two or more filter units 27 next to each other, i.e. parallel to each other. As an alternative, the filter units 27 can also be arranged consecutively, i.e. serially with respect to one another, with different filters then preferably being used. The latter arrangement is preferably selected if the requirements regarding the degree of filtering of the fluid are more exacting.

In the case of cleaning oil, use may be made, for example, of paper filters. However, other filters, for example metal filters or glass fiber filters, are likewise conceivable.

The pump 10 is operated by an electric motor (not illustrated here). The pump 10 may be, for example, a self-priming vane pump. However, a different pump may also be selected depending on the fluid in the fluid circuit.

As soon as the mobile cleaning device 1 has been connected to the fluid circuit 31, the pump 10 can be set into operation. The fluid is removed here from the fluid circuit via the connecting point 5a-5b. The fluid is conducted to the filter unit 27 by the pipe system 32. The fluid is cleaned by the filter unit 27. That is to say, impurities, for example heavy metal particles, dust particles etc., remain behind in the filter unit 27. The fluid leaves the filter unit 27 in a cleaned and accordingly usable or ready-for-use form. The pump 10 is then used to feed the fluid to the fluid circuit 31 via the pipeline system 32 and the connecting point 4a-4b. The connecting point may be, for example, the oil drain plug or the oil dipstick.

In a motor vehicle or a truck, for example, the sleeve of the oil dipstick can be used as the connecting point 5. In this case, the connecting point 5 is in the form of a probe which can be inserted into the sleeve. The probe may be, for example, of flexible or rigid design. The flexible solution is preferred if the probe is intended to be used in different types of motor vehicle. The probe is of substantially cylindrical design and has an opening which extends through the entire length of the probe and through which the oil can be removed.

The outside diameter of the probe can be within the range of 5 to 15 mm. Preferably, a set of probes having graduated diameters of 5, 6, 7, 8 and 12 mm could be provided. In addition, a sealing element, for example an O ring, which provides a sealing action between the probe and sleeve can be provided on the outside diameter of the probe.

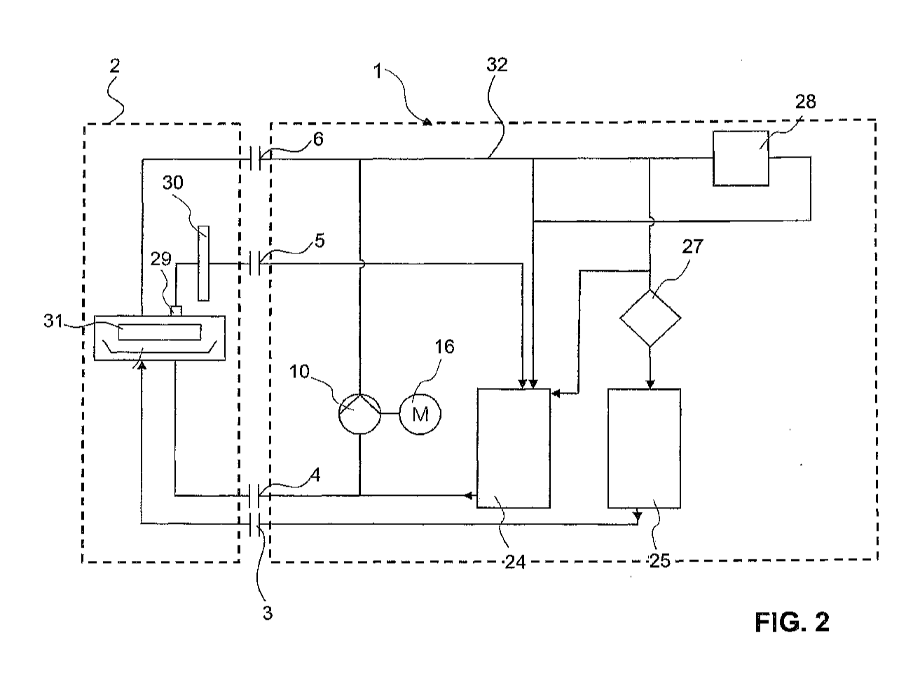

During the removal of the fluid, said fluid is removed as completely as possible from the fluid circuit of the mobile device. For the receiving of the fluid, a container which receives the fluid is arranged in the cleaning device. The container is provided with the reference number 24 in FIGS. 2 to 8.

In addition, in an alternative embodiment, it would be conceivable to operate the removal of the fluid from the mobile device without the pump. In the mobile device here, the oil is not removed from the circuit via the sleeve of the oil dipstick but rather, for example, via the oil drain point (oil drain plug) and is conducted through the device by the action of gravitational force. However, the fluid is then recirculated again in the cleaning module with a pump.

In this case, instead of the direct return, an indirect return takes place, with the oil being temporarily stored in a tank arranged in the device.

In addition, in another embodiment, it would be conceivable for the fluid to first of all be received by a collecting tank arranged on the mobile device. In this case, the connection point for removal of the fluid is integrally formed on said collecting tank and the mobile cleaning module 1 can be connected to said connection point. In this embodiment, the collecting tank should be considered as being part of the fluid circuit.

As an alternative, the mobile cleaning module may also comprise an additional container which is filled with a new or fresh fluid, which is of an identical type to that in the fluid circuit 31, and/or with an additive. Said new fluid and/or the additive can then be fed to the fluid circuit. It is thereby possible to compensate for, for example, leakage losses which may occur in the fluid circuit 31 over time.

During the cleaning of oil from a motor vehicle, the oil preferably having a temperature of approximately 60° C. is removed from the motor vehicle, this having the advantage that said oil has favorable viscosity in order, firstly, to flow through the probe and, secondly, through the filter unit 27. In the case of a motor vehicle, the user has the advantage of not having to cool the motor vehicle engine before being able to start the cleaning operation. However, in order to provide the device according to the invention with the greatest possible flexibility, a temperature element 28 can additionally be provided upstream of the filter unit 27. This temperature element 28 serves to heat or cool the liquid, thereby enabling the operating temperature for the filter unit 27 to be achieved. Heating cartridges, for example, can be used as the temperature element. It has been shown that the device can be operated particularly efficiently if a lubricating oil has a temperature within the range of, for example, 40° C. to 90° C., in particular 45° C. to 75° C., and particularly preferably above at least 50° C.

Furthermore, a metal separator 34 which is illustrated in FIG. 1 and comprises a magnet element can be provided upstream of the heating element 28. In this case, metallic elements located in the fluid remain stuck to the magnet element. The metal separator 34 is preferably designed in such a manner that it can be removed from the mobile cleaning module and replaced or cleaned.

In an alternative embodiment, the heating element 28 can also be arranged directly in the front region of the probe. This embodiment is advantageous since the fluid is heated directly in the region of the removal point, which provides better flow through the probe. In addition, the fluid is introduced already pre-heated into the mobile cleaning module 1.

The variant embodiment shown in FIG. 1 is particularly advantageous since, for example, continuous cleaning of the fluid can be provided. That is to say, in the event of a motor vehicle, the mobile cleaning module 1 is correspondingly connected to the motor vehicle 2, and then the fluid is conveyed continuously through the fluid circuit 31 of the motor vehicle and the circuit of the mobile cleaning module 1. This is carried out until the desired degree of cleanness is achieved. As an alternative, all of the fluid can also be removed from the circuit of the motor vehicle 2, the fluid then being stored in the cleaning module 1.

FIG. 2 shows a further simplified illustration of a system as per the present invention according to a second embodiment. Identical parts are provided here with the same reference numbers. The components of the mobile cleaning module 1 are summarized here by the border of dashed lines. The mobile device 2 is likewise summarized by a dashed continuous line.

The mobile device 1 again comprises a fluid circuit 31 which here optionally comprises a collecting tank 30. Furthermore, the device has a drain device 29 via which the fluid can be removed from the circuit 31.

In this embodiment, the mobile cleaning module 1 again comprises a filter unit 27, a pump 10 with a drive 16, and an optional heating device 28. Furthermore, the device comprises a storage container 24 for the uncleaned fluid and a storage container 25 for the cleaned fluid.

This embodiment is now described in more detail with reference to the further figures. In particular, the second embodiment is suitable for larger quantities of fluid, as are present, for example, in a truck. However, even relatively small quantities of fluid can easily be processed therewith. In contrast to the first embodiment, the second embodiment is preferably not operated continuously. However, it should be noted at this juncture that even the first embodiment cannot be operated continuously in an alternative embodiment. That is to say, in a first step, the fluid is removed from the fluid circuit 31 of the mobile device 2. In a second step, the cleaning or treatment of the fluid is then carried out by the mobile cleaning module 1. The return into the fluid circuit then takes place as the final step.

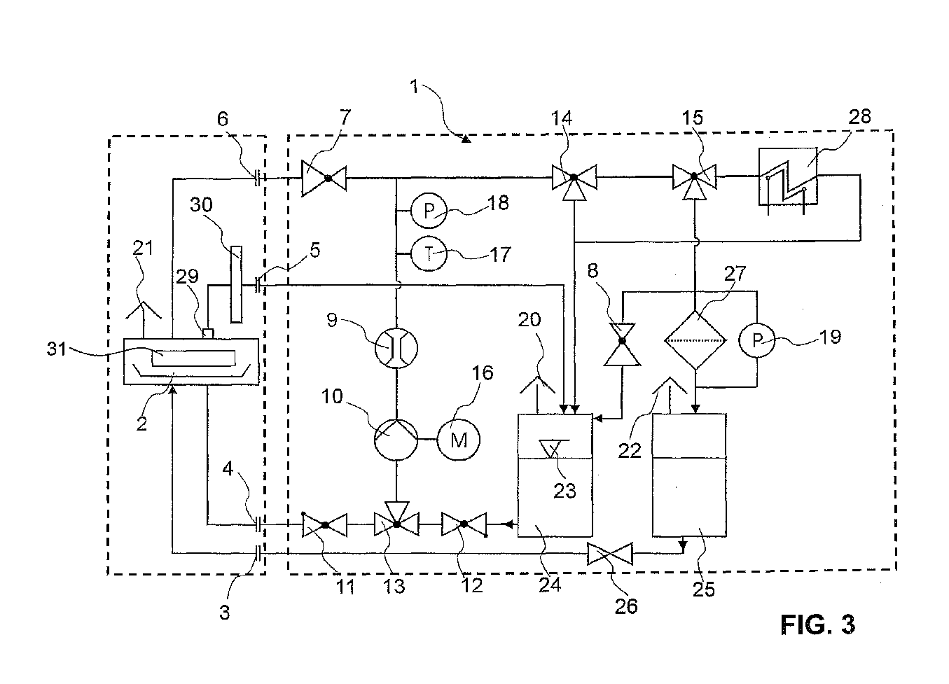

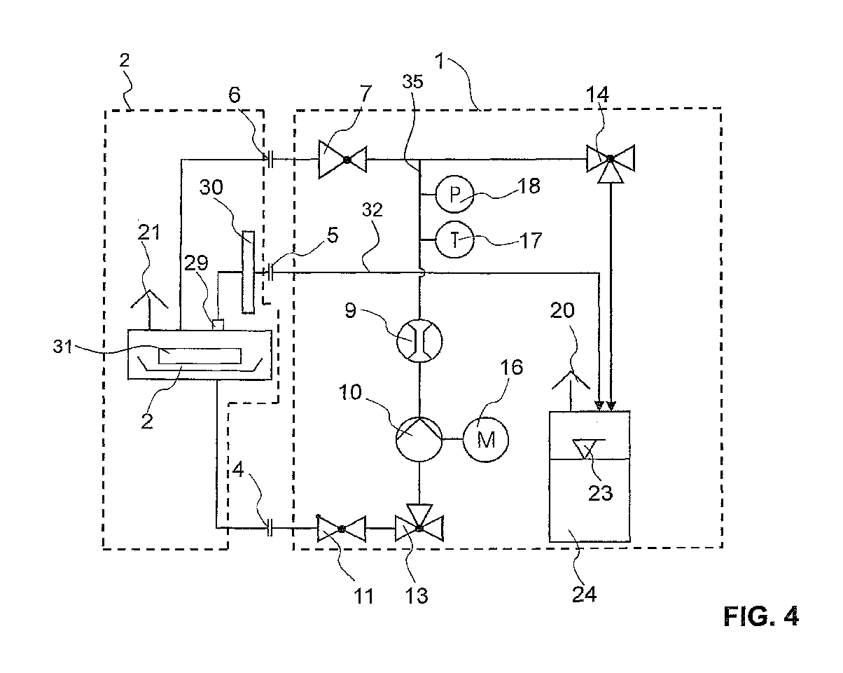

FIG. 3 shows a view of a detailed schematic diagram of a mobile cleaning module according to the second embodiment of the present invention. FIGS. 4 to 7 show details of the corresponding device parts which are explained below.

FIG. 4 illustrates the removal of the fluid from the mobile device. In this case, the mobile cleaning module provides two operating modes.

In the first operating mode, the mobile cleaning module 1 is connected to the mobile device 2 via the connection point 5. It is connected in particular to the collecting tank 30 into which the fluid can flow via the drain device 29 on the mobile device 2. The collecting tank 30 may be part of the mobile device 2 or part of the cleaning module 1. The fluid then flows via the pipeline 32 into the container 24 which temporarily stores said fluid. In this operating mode, the fluid flows into the container 24 owing to gravitational force.

In a second operating mode, the mobile cleaning module 1 is connected to the mobile device 2 via the connection point 6. In this operating mode, the fluid is actively sucked out of the fluid circuit 31 of the mobile device 2 via the pump 10. The fluid passes the coupling 4 and is conveyed by the pump 10 via the valve 13, which is located in the appropriate position, and also via the flow measuring appliance 9 into the container 24. In the event of the mobile device being overloaded, the fluid can be conducted away via the pipeline section 35.

It should be mentioned at this juncture that, furthermore, level monitoring 23 can be provided in the container 24 which receives the fluid to be cleaned, the level monitoring not only monitoring the filling level of the container but at the same time also measuring the volume of fluid removed from the fluid circuit. The volume may also be detected via flow measuring points. The volume removed may also be described as the removed volume.

Furthermore, the container 24 has a venting element 20 which, in the event of overpressure in the system, can dissipate said pressure.

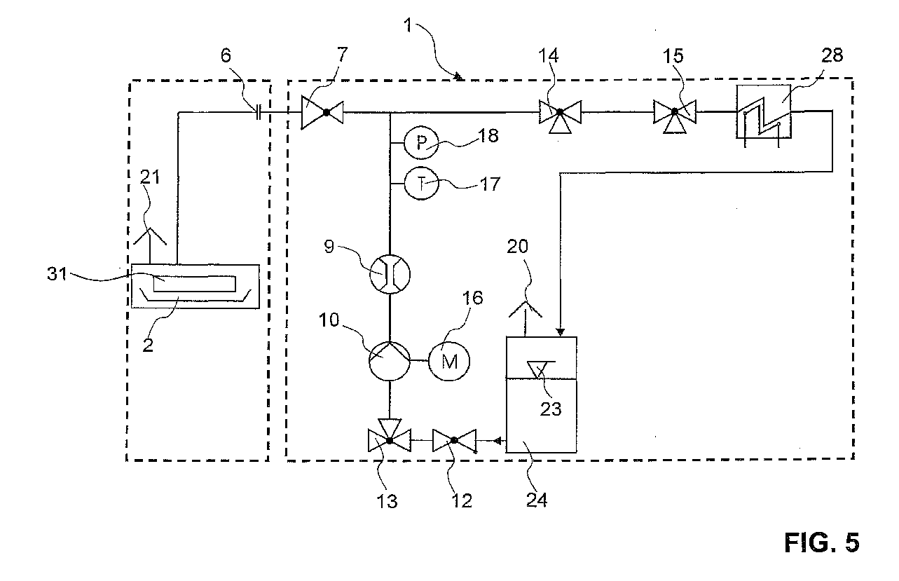

FIG. 5 shows a detailed view of the circuit for heating or cooling the fluid which is removed by the removal circuit according to FIG. 4 and is to be cleaned. In this case, the fluid to be cleaned is supplied to the temperature element 28 via the appropriately switched valve 13 and the pump 10. In the path between the pump and the temperature element 28 it is optionally possible to provide, for example, a flow measuring appliance 9, a pressure sensor 18 and/or a temperature sensor 17. The directional control valves 14, 15 are switched such that the fluid can be fed to the temperature element 28. The pressure reducing valve 7 prevents flow back into the fluid circuit of the mobile device 2. The temperature element 28 serves either to heat or to cool the fluid to be cleaned to the operating temperature of the filter unit 27. The temperature of the fluid can be monitored either by a temperature sensor in the region of the temperature element 28 or via the temperature sensor 17. Downstream of the temperature element 28, the fluid to be cleaned is fed into the container 24 again. The fluid is circulated in the circuit just described until the fluid is at the desired temperature. Advantageous temperatures have already been mentioned in conjunction with the first exemplary embodiment.

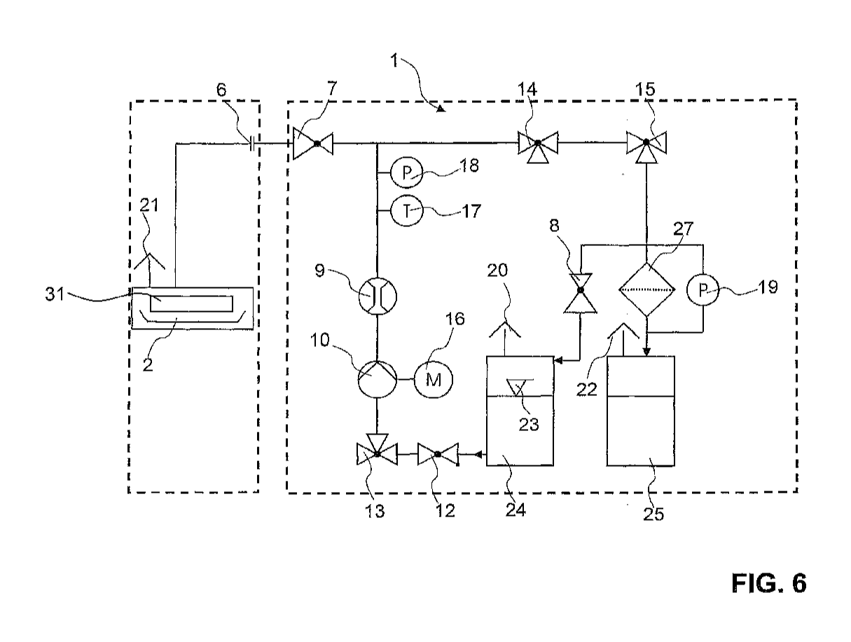

If the fluid has now reached the appropriate temperature, the cleaning circuit can be switched on in a subsequent step. FIG. 6 shows the corresponding circuit in detail. The starting point here again is the container 24 which contains the fluid to be cleaned. In this case, the fluid is circulated by the pump 10, and, in a first step, passes through the nonreturn valve 12 and the appropriately switched directional control valve 13. In a second step, the fluid is guided through the pump 10 and the following optional elements—the flow measuring appliance 9, the temperature measuring appliance 17 and pressure sensor 18. Furthermore, the fluid passes through the directional control valves 14, 15 and is finally conducted to the filter unit 27. In this exemplary embodiment, a differential pressure measuring point 19 is arranged above the filter unit 27. As soon as the fluid has passed through the filter unit, said fluid is conducted to the container 25 which temporarily stores the cleaned fluid.

The element provided with the reference number 8 is a bypass element which, in the event of clogging in the filter, returns the fluid back into the container 24. It is then indicated to the user that the filter element 27 has to be cleaned or replaced.

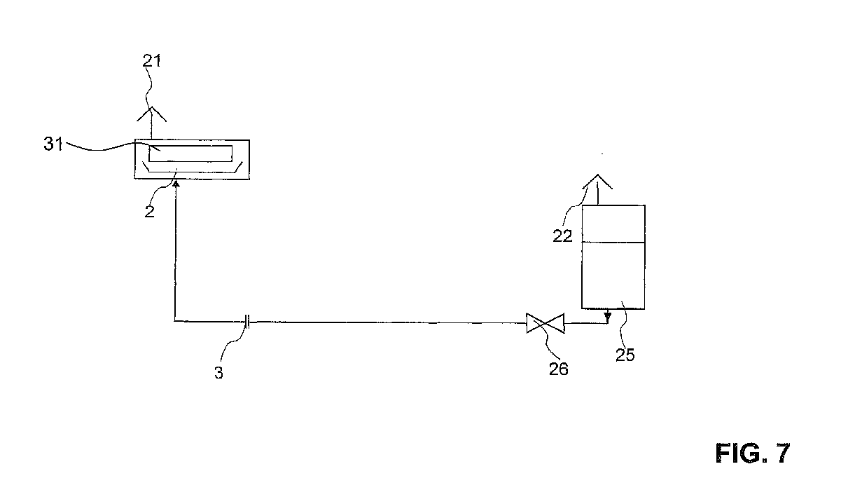

FIG. 7 now depicts the return of the cleaned fluid into the fluid circuit of the mobile device 1. In this case, the fluid leaves the container 25 via the shut off valve 26 and the adjoining connection point 3. The fluid is subsequently conducted again to the fluid circuit.

The alternatives mentioned in conjunction with the first exemplary embodiment can also be used in the second exemplary embodiment. In particular, for example, a third container can be provided containing an identical type of new fluid and/or additive which can be added to the cleaned fluid.

In all of the exemplary embodiments, it is also possible to monitor the volumetric flows via measuring means. For example, it is conceivable for the removed volume V1 (actual volume) of the fluid to be detected during or after removal of the fluid from the fluid circuit 31. A differential volume DV to a predetermined desired volume V2 can subsequently be determined. The differential volume DV can then be fed again by fresh fluid to the fluid circuit. The feeding in of the differential volume can take place, for example, after or during the return of the actual volume V1.

As an alternative, new or fresh fluid may also be added continuously to the cleaned fluid prior to being returned into the fluid circuit. In this case, the removed volume V1 (actual volume) of the fluid is optionally detected beforehand during or after removal thereof from the fluid circuit. The returned volume V2 is detected during the returning of the cleaned fluid together with the new fluid. The mobile device is operated until the returned volume V2 has reached a predetermined desired value volume. With this operating mode, the volume of the fluid in the fluid circuit can be equalized to a desired volume in a simple manner.

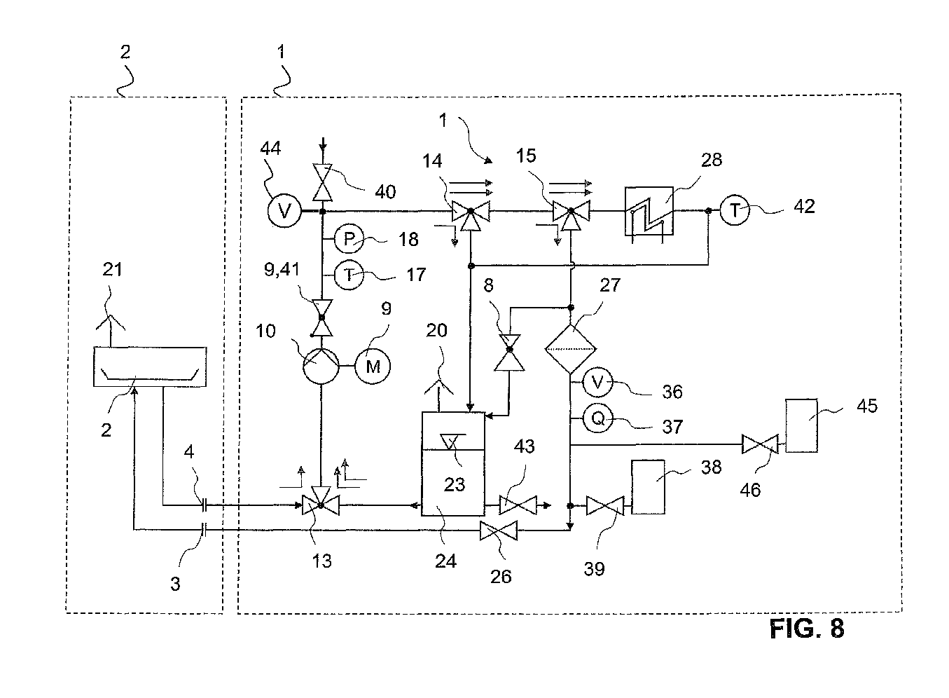

FIG. 8 shows another embodiment which is of substantially structurally identical design to the above-described exemplary embodiments, and therefore identical parts are provided with the same reference numbers.

In addition, this embodiment furthermore comprises a first viscosimeter 36 and/or a quality sensor 37, and at least one storage container for at least one additive 38 with an associated metering valve 39. The viscosimeter 36 and quality sensor 37 may also be designated as measuring means and are arranged downstream of the filter unit 27, as seen in the direction of flow of the fluid to be cleaned. That is to say, the viscosimeter 36 and the quality sensor 37 detect the corresponding fluid parameters after filtering has taken place. As an alternative or in addition, the viscosimeter 36 and/or the quality sensor 37 may also be arranged upstream of the filter unit 27. In the additional arrangement, a differential measurement between the state prior to cleaning and the state after cleaning can be carried out.

In addition, a second viscosimeter 44 can be arranged upstream of the filter unit 27, said viscosimeter measuring the viscosity of the fluid before filtering. The second viscosimeter 44 is preferably arranged in the region downstream of the pump 10 as shown in FIG. 8, or in the region shortly upstream of the filter unit 27.

A container in which the cleaned fluid is stored is preferably arranged downstream of the filter unit, as in the embodiments described above.

With the viscosimeter 36 downstream of the filter unit, the effective viscosity of the cleaned fluid can be determined. This involves the fluid which is recycled to the circuit of the mobile device. Said actual value can then be compared with a predefined desired viscosity value which is dependent on the specification of the mobile device, i.e. for example, on a motor vehicle or a truck. If the actual value now corresponds to the desired value or lies within a predetermined range of tolerances, the cleaned fluid is brought back to the circuit of the mobile device 2 via the shut off valve 26 and the connection point 3. If the actual value now differs from the desired value or lies outside the range of tolerances, an additive is fed, as described below from the additive container 38 to the cleaned fluid via the metering valve 39 such that the actual value of the viscosity of the fluid to be returned is corrected such that said actual value comes to lie within the range of tolerances of the desired value.

In this context, the term additive can be understood as meaning a fluid of identical type to the cleaned fluid and/or a fluid of a type different from the cleaned fluid, i.e. an additive within the narrower sense. If both an additive and an identical type of fluid are intended to be added, there can be two separate storage containers, with the latter inputting the fluid into the cleaned fluid either jointly via a single metering valve 39 or via two different metering valves.

In an alternative embodiment, there may also be a plurality of containers of the identical type of fluid, wherein the fluids then have different viscosities. A fluid having the required viscosity can then be mixed with said fluids. In this case, actual values which are too low can be equalized with a fluid having high viscosity and actual values which are too high can be equalized with a fluid having low viscosity.

Accordingly, if the actual value differs from the desired value or from the range of tolerances, an identical type of fluid and/or an additive are/is added to the cleaned fluid such that that the fluid state is improved.

In this case, the volume to be added of the identical type of fluid or of the additive is determined on the basis of measuring the volume of the fluid removed from the oil circuit. The composition of the volume to be added is determined on the basis of the difference between the desired value and actual value.

It is advantageous if the viscosimeter 36 measures the viscosity during the entire cleaning operation and, in the process, determines an average value which is compared with the desired value. On the basis of the result of this comparison and of the volume of fluid removed, the volume to be added is then determined. As an alternative, the viscosity may also be measured for a specific time window which is part of the overall cleaning operation time, with the average value then being determined from this measurement.

The quantity to be added is preferably composed of 1% to 5%, particularly preferably of 2% to 3% of additives and of 99% to 95%, particularly preferably of 98% to 97% of an identical type of fluid.

A major advantage of this manner of determining the viscosity and the subsequent correction to the desired value resides the in the simplicity of the method. A complicated measuring arrangement is unnecessary since only the viscosity and the volume of the removed fluid have to be detected here and the quantity to be added and composition which determines the viscosity of the fluid or additive to be added can be determined therefrom.

The following example clarifies the method. According to the manufacturer's specification, the oil in the oil circuit of a motor vehicle has to have a viscosity of 5W30. The viscosity can be changed, for example to 5W40, by the operation, this being detected by the viscosimeter 36. By means of the addition of fresh oil, the viscosity of the cleaned oil to be returned can be adapted again. At the same time, an additive may also be added, this either likewise having a positive influence on the viscosity and/or providing the oil to be returned with further properties.

If it is not possible to equalize the viscosity due to excessive differences, the fluid is removed from the system upstream of the opening of the metering valve 39 into the pipeline system and is poured into a tank. Said fluid is then destined for disposal. After the fluid has been removed, fresh fluid is conducted via the storage container 38 and the metering valve and via the cleaning device into the mobile device.

By means of the viscosimeter 44 upstream of the filter unit, the viscosity can be determined upstream of the filter unit, wherein said determination permits conclusions to be drawn regarding possible damage to the mobile device.

In the present embodiment, the quality sensor 37, which can be arranged in addition or alternatively to the viscosity measurement, serves, for example, to detect the particles still remaining in the fluid, wherein, if a limit value is exceeded, it is indicated to the user to change the filter.

As an alternative or in addition, a quality sensor may also be arranged upstream of the filter, this permitting measurement of particles in the uncleaned fluid. On the basis of the number and/or type of particles, this permits a conclusion to be drawn regarding the wear of the engine.

If a considerable lack of quality of the fluid to be returned is now established either by the viscosimeter 36 or by the quality sensor 37, the shut off valve 26 is closed and therefore prevents the fluid affected by the lack of quality from passing back into the circuit of the mobile device. The mobile device is then filled by fresh fluid.

The mobile cleaning module embodiments described herein can furthermore be equipped with a transmitting unit which supplies data regarding the state of the mobile cleaning device to a central computer. The data may also contain the precise location which is established via a GPS module (not shown in the drawings).

List of reference numbers

| | |
|---|---|
| 1 | Mobile cleaning module |
| 2 | Mobile device |
| 3 | Connection point |
| 4 | Connection point |
| 5 | Connection point |
| 6 | Connection point |
| 7 | Pressure reducing valve |
| 8 | Pressure reducing valve |
| 9 | Flow measuring appliance |
| 10 | Pump |
| 11 | Nonreturn valve |
| 12 | Nonreturn valve |
| 13 | Directional control valve |
| 14 | Directional control valve |
| 15 | Directional control valve |
| 16 | Electric motor |
| 17 | Temperature sensor |
| 18 | Pressure sensor |
| 19 | Differential pressure measuring point above the filter |
| 20 | Venting element |
| 21 | Venting element |
| 22 | Venting element |
| 23 | Level monitoring |
| 24 | Container for fluid to be cleaned |
| 25 | Container for cleaned fluid |
| 26 | Shut off valve |
| 27 | Filter unit |
| 28 | Temperature element |
| 29 | Drain device on engine |
| 30 | Collecting tank |
| 31 | Fluid circuit |
| 32 | Pipe system |
| 33 | Collecting tank |
| 34 | Metal separator |
| 35 | Branch |
| 36 | Viscosimeter |
| 37 | Quality sensor |
| 38 | Storage container for additives |
| 39 | Metering valve |
| 40 | Compressed air connection |
| 41 | Nonreturn valve |
| 42 | Temperature sensor |
| 43 | Drain valve |
| 44 | Second viscosimeter |
| 45 | Tank |
| 46 | Valve |

1.-17. (canceled)

18. A cleaning method for fluids of a fluid circuit of a mobile device with a mobile cleaning module,
wherein the mobile cleaning module comprises
at least one connecting element for providing a connection to the fluid circuit such that the fluid can be removed from the fluid circuit,
at least one filter unit for cleaning the fluid, and
a connecting element for providing a connection to the fluid circuit such that the fluid can be fed back to the fluid circuit,
wherein according to the method
in a first step, the mobile cleaning module is connected to the fluid circuit via at least one connecting element; wherein
in a subsequent step, the fluid is at least partially removed from the fluid circuit; wherein
in a subsequent step, the temperature of the fluid is brought to a predetermined temperature and, after the predetermined temperature is reached, is guided through the filter unit; wherein
upstream and/or downstream of the filter unit, a physical property and/or a chemical property of the fluid is determined, and
in a final step, the cleaned fluid is fed back to the fluid circuit of the mobile device.

19. The method as claimed in claim 18, wherein the fluid is completely removed from the circuit.

20. The method as claimed in claim 18, wherein the fluid is heated or cooled during the step of changing the fluid temperature.

21. The method as claimed in claim 18, wherein the determination of the property comprises measuring an actual value of the viscosity by means of a viscosimeter, and wherein said actual value is compared with a predetermined desired value, wherein during the measurement of the viscosity downstream of the filter unit and upon a predetermined difference between the actual value and desired value being exceeded, the viscosity being corrected by adding an additive and/or a fluid of a type identical to the fluid.

22. The method as claimed in claim 18, wherein the determination of the property comprises measuring an actual value of the viscosity by means of a viscosimeter (37), and wherein said actual value is compared with a predetermined desired value, wherein during the measurement of the viscosity downstream of the filter unit and upon a predetermined difference between the actual value and desired value being exceeded, the fluid being guided into a tank of the cleaning device, with fresh fluid then being fed to the mobile device.

23. The method as claimed in claim 18, wherein the determination of the property comprises detecting the number of metallic particles in the fluid, wherein during the determination upstream of the filter unit and if the number of detected particles is greater than a predefined value, a warning signal being generated alerting the user to a defect at the mobile device.

24. The method as claimed in claim 18, wherein the determination of the property comprises detecting the number of metallic particles in the fluid, wherein during the determination downstream of the filter unit and upon a predetermined difference between the actual value and desired value being exceeded, the fluid being guided into a tank of the cleaning device, with fresh fluid then being fed to the mobile device.

25. The method as claimed in claim 18, wherein upstream and/or downstream of the filter unit, a predetermined volume of fluid is guided through a shut off member into at least one external container, the volume removed being compensated for by fresh fluid being fed in prior to being returned.

26. The method as claimed in claim 18, wherein the viscosity is measured continuously during the entire cleaning operation, an average value which corresponds to the actual value being formed continuously.

27. The method as claimed in claim 18, wherein the viscosity is measured during a time window, an average value which corresponds to the actual value being formed over the duration of the time window.

28. The method as claimed in claim 18, wherein upon or after removal of the fluid from the fluid circuit, the mobile device detects the removed volume removed from the device, an additive and/or the identical type of fluid being added after the step of determining the viscosity of fluid until a predetermined desired volume is achieved, the added parts being selected such that the viscosity is corrected to a predetermined desired value.

29. The method as claimed in claim 18, wherein the predetermined temperature lies within the range of 40° C. to 90° C., in particular in the range of 45° C. to 75° C. particularly preferably above at least 50° C.

30. The method as claimed in claim 18, wherein an additive is added to the cleaned fluid by the mobile cleaning module.

31. The method as claimed in claim 18, wherein the mobile cleaning module is connected to said mobile device, and then the fluid is conveyed continuously through the fluid circuit of the motor vehicle and the circuit of the mobile cleaning module.

32. A mobile cleaning module for carrying out the method as claimed in claim 18, wherein the mobile cleaning device comprises
at least one connection point for connecting to the at least one connection point of the mobile device,
a temperature element,
at least one measuring element for determining at least one physical property and/or at least one chemical property of the fluid, and
a filter unit which is connected to the at least one connection point via a pipeline system,
wherein the fluid being at least partially removable from the fluid circuit of the mobile device via the connection of the connection points of the mobile device to those of the mobile cleaning module,
the temperature of the fluid being changeable to a predetermined temperature with the temperature element (27) and, after reaching the predetermined temperature, being guidable through the filter element and being cleanable,
the at least one measuring element being arranged upstream and/or downstream of the filter unit, and
the cleaned fluid being feedable back into the fluid circuit (31) via said connection.

33. The mobile cleaning module as claimed in claim 32, wherein the cleaning module furthermore comprises a pump by means of which the fluid can be removed from the fluid circuit.

34. The mobile cleaning module as claimed in claim 32, wherein the connection point on the mobile cleaning module is designed as a probe which can be inserted into the fluid circuit.

35. The mobile cleaning module as claimed in claim 32, wherein the cleaning module comprises an additional container for receiving the cleaned fluid and/or a new fluid and/or an additive, the fluid in the additional container being dispensable into the fluid circuit (31) of the mobile device.

36. The mobile cleaning module as claimed in claim 32, wherein the cleaning module comprises a container in which the removed fluid can be stored, and wherein the cleaning module comprises a further container in which the cleaned fluid can be stored.

37. The mobile cleaning module as claimed in claim 32, wherein the cleaning module comprises measuring element for detecting the actual volume of the fluid removed from the fluid circuit and elements for calculating a differential volume between the actual volume and a predetermined desired volume.

38. The mobile cleaning module as claimed in claim 32, wherein the measuring elements is a viscosimeter which is arranged downstream of the filter unit and with which the actual value of the viscosity of the fluid can be determined, the actual value being able to be compared with a predetermined desired value, and
wherein upon a predetermined difference between the actual value and desired value being exceeded, the viscosity can be corrected by adding an additive and/or a fluid of identical type to the fluid via a storage container which is connected to the line system and has a metering device.

39. The mobile cleaning module as claimed in claim 32, wherein the measuring elements is a viscosimeter which is arranged downstream of the filter unit and with which the actual value of the viscosity of the fluid can be determined, the actual value being able to be compared with a predetermined desired value, and wherein upon a predetermined difference between the actual value and desired value being exceeded, the fluid is guided into a tank of the cleaning device, with fresh fluid then being fed to the mobile device.

40. The mobile cleaning module as claimed in claim 32, wherein the measuring elements is at least one quality sensor which is arranged upstream and/or downstream of the filter unit and with which the metallic particles in the fluid can be detected, wherein during the determination upstream of the filter unit and if the number of detected particles is greater than a predefined value, a warning signal being generated alerting the user to a defect at the mobile device.

41. The mobile cleaning module as claimed in claim 32, wherein the measuring elements is at least one quality sensor which is arranged upstream and/or downstream of the filter unit and with which the metallic particles in the fluid can be detected, wherein during the determination downstream of the filter unit and upon a predetermined deviation between the actual value and desired value being exceeded, the fluid being guided into a tank of the cleaning device, with fresh fluid then being fed to the mobile device.

42. The mobile cleaning module as claimed in claim 32, wherein a viscosimeter is arranged upstream of the filter unit.
